(19) United States
(12) Patent Application Publication
(10) Pub. No.: US 2020/0408261 A1
(43) Pub. Date: Dec. 31, 2020

(54) ROLLING BEARING AND METHOD OF MANUFACTURING THE SAME

(71) Applicant: NTN Corporation, Osaka (JP)

(72) Inventors: Masaki NAKANISHI, Kuwana-shi, Mie (JP); Hidenobu MIKAMI, Kuwana-shi, Mie (JP)

(21) Appl. No.: 16/492,090

(22) PCT Filed: Mar. 6, 2018
(86) PCT No.: PCT/JP2018/008623

§ 371 Date: Sep. 6, 2019

(30) Foreign Application Priority Data
Mar. 7, 2017 (JP) 2017-042576
Nov. 14, 2017 (JP) 2017-218848

(51) Int. Cl. F16C 33/62; F16C 19/06

(52) U.S. Cl. CPC F16C 33/62; F16C 2206/82; F16C 2204/44; F16C 19/06

(57) ABSTRACT

A rolling bearing excellent in durability is provided. A rolling bearing includes an inner ring, an outer ring, a plurality of rolling elements, and a hard film. The hard film is formed on a surface of at least one selected from the group consisting of the inner ring, the outer ring, and the rolling elements. The hard film includes an underlying layer, a mixed layer, and a surface layer. The underlying layer is directly formed on the surface and mainly composed of Cr. The mixed layer is formed on the underlying layer and mainly composed of WC and DLC. The surface layer is formed on the mixed layer and mainly composed of DLC. The mixed layer is such a layer that a content of WC therein decreases and a content of DLC therein increases continuously or stepwise from a side of the underlying layer toward the surface layer.

### TECHNICAL FIELD

The present invention relates to a rolling bearing and a method of manufacturing the same, and more particularly to a rolling bearing in which a hard film containing diamond like carbon is formed on a surface of an inner ring, an outer ring, and a rolling element and a method of manufacturing the same.

### BACKGROUND ART

A hard carbon film generally refers to a hard film called diamond like carbon (which will be denoted as DLC below; a film or a layer mainly composed of DLC being also referred to as a DLC film or a DLC layer). Though hard carbon is variously referred to as hard non-crystalline carbon, amorphous carbon, hard amorphous carbon, i-carbon, or diamond-like carbon other than the above denotation, these terms are not clearly distinguished from one another.

DLC for which such terms are used is essentially a mixture of diamond and graphite in an aspect of its structure. DLC has a structure intermediate between diamond and graphite. DLC is as high in hardness as diamond and excellent in wear resistance, solid lubrication, thermal conductivity, chemical stability, and corrosion resistance. Therefore, DLC has increasingly been used, for example, for dice and tools, a wear-resistant mechanical component, a polishing material, a sliding member, and a protective film for a magnetic and optical component. Physical vapor deposition (which is denoted as PVD below) such as sputtering or ion plating, chemical vapor deposition (which is denoted as CVD below), and unbalanced magnetron sputtering (which is denoted as UBMS below) have been adopted as a method of forming such a DLC film.

An attempt to form a DLC film on a raceway surface of a rolling bearing ring or a rolling surface of a rolling element in a rolling bearing has conventionally been made. Extremely large internal stress is produced in the DLC film during film formation. The DLC film has a high hardness and a high Young's modulus whereas it is extremely low in ductility. Therefore, the DLC film is low in adhesiveness to a substrate and disadvantageous in its tendency toward flaking. In forming a DLC film on a raceway surface of a rolling bearing ring or a rolling surface of a rolling element in a rolling bearing, adhesiveness should be improved.

For example, a rolling apparatus in which an underlying layer composed of at least any element of chromium (which is denoted as Cr below), tungsten (which is denoted as W below), titanium (which is denoted as Ti below), silicon (which is denoted as Si below), nickel (which is denoted as Ni below), and iron, an intermediate layer containing a constituent element of the underlying layer and carbon and being higher in content of carbon on a side opposite to the underlying layer than a side of the underlying layer, and a DLC layer composed of argon and carbon where a content of argon is not lower than 0.02 mass % and not higher than 5 mass % are formed in this order on a raceway groove of a rolling bearing ring or a rolling surface of a rolling element formed of an iron steel material has been proposed as improvement in adhesiveness of the DLC film by providing the intermediate layer between a substrate and the DLC film (see Japanese Patent Laying-Open No. 2003-314560).

Furthermore, a rolling bearing in which projections and recesses having an average width not greater than 300 nm are formed at a height from 10 to 100 nm on a raceway surface of a rolling bearing ring by ion bombardment treatment and a DLC film is formed on the raceway surface has been proposed as improvement in adhesiveness of the DLC film by an anchoring effect (see Japanese Patent Laying-Open No. 2001-304275).

### CITATION LIST

### Patent Literature

PTL 1: Japanese Patent Laying-Open No. 2003-314560

PTL 2: Japanese Patent Laying-Open No. 2001-304275

### SUMMARY OF INVENTION

### Technical Problem

It is not easy, however, to secure resistance against flaking of a coating under a high contact pressure produced in a rolling bearing. In particular, under a lubrication and operation condition in which strong shear force may be produced in a coating due to sliding friction, it is more difficult to secure resistance against flaking of the coating.

A sliding surface to which application of DLC is considered is often in such a condition as poor lubrication and occurrence of sliding, which is severer than an operation condition in a general rolling bearing.

Wear not only in a rolling contact surface but also in an outer circumferential surface or an end surface and sliding resistance in a sealing groove may also give rise to a problem of a bearing. Therefore, DLC treatment in a portion other than a rolling contact surface in a bearing is also effective for improvement in durability and functionality of the bearing.

The present invention was made to address such problems, and an object thereof is, for example, to provide a rolling bearing excellent in durability by improving resistance against flaking of a DLC film formed on an inner-ring or outer-ring raceway surface of a rolling bearing to thereby exhibit characteristics inherent to the DLC film.

### Solution to Problem

A rolling bearing according to the present disclosure includes an inner ring, an outer ring, a plurality of rolling elements, and a hard film. The inner ring includes an inner-ring raceway surface around an outer circumference. The outer ring includes an outer-ring raceway surface around an inner circumference. The plurality of rolling elements roll between the inner-ring raceway surface and the outer-ring raceway surface. The hard film is formed on a surface of at least one selected from the group consisting of the inner ring, the outer ring, and the rolling elements. The inner ring, the outer ring, and the plurality of rolling elements are composed of an iron-based material. The hard film includes an underlying layer, a mixed layer, and a surface layer. The underlying layer is directly formed on the surface and mainly composed of chromium. The mixed layer is formed on the underlying layer and mainly composed of tungsten carbide (WC) and diamond like carbon (DLC). The surface layer is formed on the mixed layer and mainly composed of diamond like carbon (DLC). The mixed layer is such a layer that a content of tungsten carbide (WC) therein decreases and a content of diamond like carbon (DLC) therein increases continuously or stepwise from a side of the underlying layer toward the surface layer.

A method of manufacturing the rolling bearing includes preparing the inner ring, the outer ring, and the rolling elements and forming the hard film. In the forming the hard film, the hard film is formed on the surface of at least one selected from the group consisting of the inner ring, the outer ring, and the rolling elements. In the forming the hard film, an unbalanced magnetron sputtering apparatus in which argon gas is employed as sputtering gas is used. In the forming the hard film, a graphite target and a hydrocarbon-based gas are used together as a carbon supply source, and a ratio of an amount of introduction of the hydrocarbon-based gas to an amount of introduction defined as 100 of the argon gas into the apparatus is not lower than 1 and not higher than 10. In the forming the hard film, the surface layer is formed by deposition of carbon atoms originating from the carbon supply source on the mixed layer.

### Advantageous Effects of Invention

According to the above, a rolling bearing excellent in durability can be realized by improving resistance against flaking of a hard film including a layer formed on an inner-ring or outer-ring raceway surface of a rolling bearing and mainly composed of DLC to thereby exhibit characteristics inherent to DLC.

### BRIEF DESCRIPTION OF DRAWINGS

FIG. 1 is a schematic cross-sectional view of a rolling bearing according to an embodiment of the present invention.

FIG. 2 is a schematic cross-sectional view of the rolling bearing according to the embodiment of the present invention.

FIG. 3 is a schematic cross-sectional view of the rolling bearing according to the embodiment of the present invention.

FIG. 4 is a schematic cross-sectional view of a rolling element of the rolling bearing shown in FIG. 3.

FIG. 5 is a partial schematic cross-sectional view of a hard film of the rolling bearing shown in FIG. 1.

FIG. 6 is a flowchart for illustrating a method of manufacturing a rolling bearing according to the embodiment of the present invention.

FIG. 7 is a schematic diagram for illustrating principles in film formation by an UBMS method.

FIG. 8 is a schematic diagram showing a construction of an exemplary UBMS apparatus.

FIG. 9 is a schematic diagram showing a construction of a reciprocating-motion sliding test apparatus.

### DESCRIPTION OF EMBODIMENTS

An embodiment of the present invention will be described below with reference to the drawings. The same or corresponding elements in the drawings below have the same reference characters allotted and description thereof will not be repeated.

(Embodiment)

A hard film such as a DLC film has residual stress therein. Residual stress is greatly varied as being affected by a structure of the hard film, a film formation condition, and a shape of a substrate on which the hard film is formed. The present inventors have found as a result of a number of experiments that a shape of a substrate unexpectedly greatly affects residual stress. For example, in a hard film formed on a plane, flaking immediately after film formation is not observed and a critical load in a scratch test is also high. When a hard film identical in structure is formed on a curved surface such as an inner-ring raceway surface and an outer-ring raceway surface of a rolling bearing, however, in some cases, the hard film flakes off immediately after film formation or flakes off during use although it does not flake off immediately after film formation. The present inventors have found as a result of dedicated studies that resistance against flaking can significantly be improved by limiting a hard film to be formed on an inner-ring raceway surface, an outer-ring raceway surface, and a rolling surface of a rolling element in a rolling bearing which are curved surfaces to have a prescribed structure constituted of an underlying layer (mainly composed of Cr), a mixed layer (having a gradient composition of WC/DLC), and a surface layer (mainly composed of DLC). Flaking of the hard film constituted as such can be suppressed also under an actual condition of use of a bearing. Furthermore, resistance against flaking can further be improved by setting an indentation hardness of the surface layer to 10 to 20 GPa. The present invention was made based on such findings.

<Construction of Rolling Bearing>

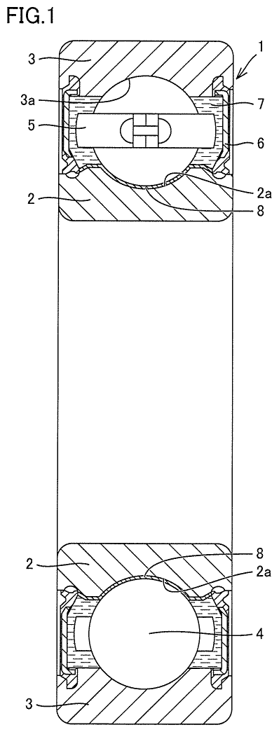

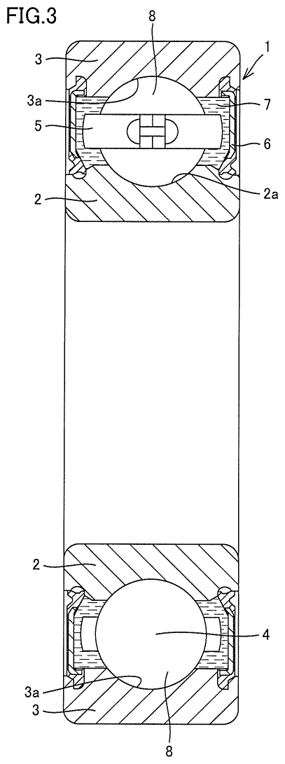

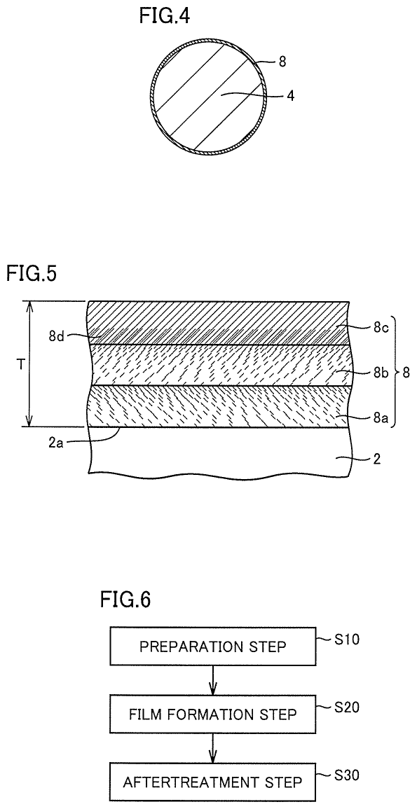

FIGS. 1 to 3 are each a schematic cross-sectional view of a rolling bearing according to an embodiment of the present invention (which is also described as the present embodiment below). FIG. 4 is a schematic cross-sectional view of a rolling element of the rolling bearing shown in FIG. 3. FIG. 5 is a partial schematic cross-sectional view of a hard film of the rolling bearing shown in FIG. 1.

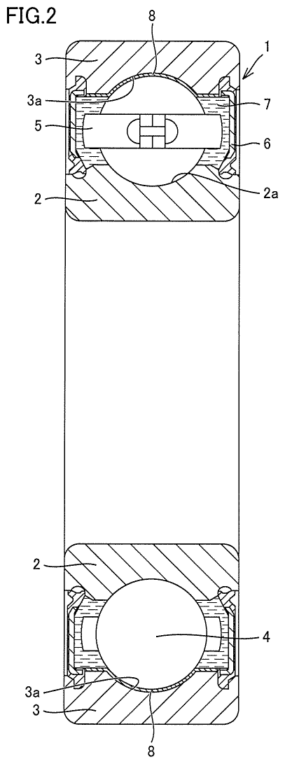

A rolling bearing according to the present embodiment will be described with reference to FIGS. 1 to 5. FIG. 1 shows a cross-sectional view of a deep-groove ball bearing representing one example of a rolling bearing in which a hard film which will be described later is formed on an inner-ring raceway surface. FIG. 2 shows a cross-sectional view of a deep-groove ball bearing in which a hard film which will be described later is formed on an outer-ring raceway surface. FIG. 3 shows a cross-sectional view of a deep-groove ball bearing in which a hard film is formed on a rolling surface of a rolling element.

A rolling bearing 1 shown in FIGS. 1 to 3 includes an inner ring 2 including an inner-ring raceway surface 2a around an outer circumference, an outer ring 3 including an outer-ring raceway surface 3a around an inner circumference, and a plurality of rolling elements 4 which roll between inner-ring raceway surface 2a and outer-ring raceway surface 3a. Rolling elements 4 are held at regular intervals by a cage 5. A sealing member 6 seals openings at opposing axial ends between the inner ring and the outer ring. Grease 7 is sealed in a bearing space sealed by sealing member 6. Known grease for a rolling bearing can be employed for grease 7 provided around rolling elements 4.

For example, in rolling bearing 1 shown in FIG. 1, a hard film 8 is formed on an outer circumferential surface of inner ring 2 including inner-ring raceway surface 2a. In rolling bearing 1 shown in FIG. 2, hard film 8 is formed on an inner circumferential surface of outer ring 3 including outer-ring raceway surface 3a.

In rolling bearing 1 shown in FIG. 3, hard film 8 is formed on a rolling surface which is a surface of rolling element 4 as shown in FIG. 4. Since rolling bearing 1 in FIG. 3 is a deep-groove ball bearing, rolling element 4 is spherical and the entire spherical surface thereof serves as the rolling surface. A cylindrical roller bearing or a tapered roller bearing may be employed as a rolling bearing other than the manner shown in FIGS. 1 to 3. When hard film 8 is formed on a surface of a rolling element of such a bearing, hard film 8 should only be formed at least on a rolling surface of the rolling element such as an outer circumferential surface of the cylindrical roller. In rolling bearing 1, hard film 8 should only be formed on at least one surface of inner ring 2, outer ring 3, or rolling element 4 depending on an application.

As shown in FIGS. 1 to 3, inner-ring raceway surface 2a of the deep-groove ball bearing is formed as an annularly curved surface of which axial cross-section is in an arc-shaped groove for guiding the ball serving as rolling element 4. Similarly, outer-ring raceway surface 3a is also formed as an annularly curved surface of which axial cross-section is in an arc-shaped groove. The arc-shaped groove has a radius of curvature approximately from 0.51 dw to 0.54 dw with a diameter of a ball (a steel ball diameter) being generally defined as dw. When a cylindrical roller bearing or a tapered roller bearing is employed as a rolling bearing other than the manner shown in FIGS. 1 to 3, the inner-ring raceway surface and the outer-ring raceway surface are formed as a curved surface at least in a circumferential direction in order to guide rollers of the bearing. When a self-aligning roller bearing is employed as a rolling bearing, a barrel-shaped roller is employed as the rolling element and hence the inner-ring raceway surface and the outer-ring raceway surface are formed as curved surfaces not only in the circumferential direction but also in an axial direction. Rolling bearing 1 according to the present embodiment may have inner-ring raceway surface 2a and outer-ring raceway surface 3a in any shape above.

In rolling bearing 1 according to the present embodiment, inner ring 2, outer ring 3, and rolling elements 4 which are bearing members on which hard film 8 is to be formed are composed of an iron-based material. The iron-based material refers to a material mainly composed of iron. Any steel material generally used for a bearing member can be employed as the iron-based material, and examples thereof include high-carbon chromium bearing steel, carbon steel, tool steel, and martensitic stainless steel.

In such a bearing member, a surface on which hard film 8 is to be formed may have a Vickers hardness not lower than Hv 650. By setting a hardness not lower than Hv 650, difference in hardness from hard film 8 (more specifically, an underlying layer 8a shown in FIG. 5) is made smaller so that adhesiveness of hard film 8 to the bearing member can be improved.

On a surface of the bearing member on which hard film 8 is to be formed, a nitride layer may be formed by nitriding treatment before formation of hard film 8. Plasma nitriding treatment in which an oxide layer interfering adhesiveness is less likely to be formed on the surface of the bearing member serving as a substrate is preferably performed as nitriding treatment. A surface of the nitride layer after nitriding treatment may have a Vickers hardness not lower than Hv 1000. In this case, adhesiveness of hard film 8 to the bearing member can further be improved.

The surface of the bearing member on which hard film 8 is to be formed may have surface roughness Ra not greater than 0.05 μm. When surface roughness Ra exceeds 0.05 μm, hard film 8 is less likely to be formed on a tip end of a projection of irregularities of the surface and hard film 8 may locally be small in thickness.

In rolling bearing 1, a surface layer 8c may have an indentation hardness not lower than 10 GPa and not higher than 20 GPa. In this case, resistance against flaking of hard film 8 can be improved. The indentation hardness may be not higher than 18 GPa and not higher than 15 GPa. The indentation hardness may be not lower than 12 GPa and not lower than 13 GPa.

A specific structure of hard film 8 in rolling bearing 1 according to the present embodiment will be described with reference to FIG. 5. FIG. 5 shows a structure of hard film 8 in rolling bearing 1 shown in FIG. 1. As shown in FIG. 5, hard film 8 includes a three-layered structure constituted of underlying layer 8a, a mixed layer 8b, and a surface layer 8c. Underlying layer 8a is directly formed on inner-ring raceway surface 2a of inner ring 2 and mainly composed of Cr. Mixed layer 8b is formed on underlying layer 8a and mainly composed of WC and DLC. Surface layer 8c is formed on mixed layer 8b and mainly composed of DLC. In mixed layer 8b, a content of WC decreases and a content of DLC increases continuously or stepwise from a side of underlying layer 8a toward surface layer 8c.

Since underlying layer 8a is mainly composed of Cr, compatibility is good between inner ring 2 representing the bearing member as the substrate made of the iron-based material and underlying layer 8a. Therefore, adhesiveness of underlying layer 8a to the bearing member serving as the substrate is higher than an example in which W, Ti, or Si is employed for underlying layer 8a. In particular, when high-carbon chromium bearing steel employed as a material for a rolling bearing ring of a bearing is employed as a material for the bearing member, underlying layer 8a mainly composed of Cr is excellent in adhesiveness to the bearing member.

WC employed for mixed layer 8b has a hardness and an elastic modulus intermediate between Cr and DLC. Therefore, concentration of residual stress after formation of hard film 8 is also less likely. Thus, when hard film 8 containing DLC excellent in resistance against flaking is formed on the inner-ring raceway surface, the outer-ring raceway surface, and the rolling surface of the rolling element of the rolling bearing formed as the curved surface, selection of a material for mixed layer 8b as an intermediate layer in hard film 8 is also an important factor.

Mixed layer 8b has such a gradient composition that a content of WC decreases and a content of DLC increases toward surface layer 8c. Therefore, mixed layer 8b is excellent in adhesiveness at both of an interface with underlying layer 8a and an interface with surface layer 8c. In particular, WC and DLC are physically bonded in mixed layer 8b and a content of DLC is higher on the side of surface layer 8c in mixed layer 8b. Therefore, adhesiveness between surface layer 8c and mixed layer 8b is excellent.

Surface layer 8c is mainly composed of DLC. Surface layer 8c preferably includes on a side adjacent to mixed layer 8b, a gradient layer portion 8d having a hardness increasing continuously or stepwise from a side of mixed layer 8b toward an opposite side (toward an upper surface of surface layer 8c). This is a portion obtained by varying a bias voltage (for example, increasing a set value of a bias voltage) continuously or stepwise for avoiding abrupt change in bias voltage when bias voltages in formation of mixed layer 8b and surface layer 8c are different from each other. By thus varying the bias voltage, gradient layer portion 8d has consequently a hardness varied in a direction of thickness of surface layer 8c as above. Continuous or stepwise increase in hardness results from the fact that a composition ratio of a diamond structure (sp3) to a graphite structure (sp2) in a DLC structure is higher owing to increase in bias voltage. Abrupt variation in hardness in an interface region between mixed layer 8b and surface layer 8c is thus lessened and adhesiveness between mixed layer 8b and surface layer 8c is further improved.

Hard film 8 may have a thickness (a total thickness of underlying layer 8a, mixed layer 8b, and surface layer 8c) not smaller than 0.5 μm and not greater than 3.0 μm. When the thickness is smaller than 0.5 μm, wear resistance and mechanical strength of hard film 8 may be insufficient. When the thickness exceeds 3.0 μm, hard film 8 may be likely to flake off. A ratio of a thickness of surface layer 8c occupied in the thickness of hard film 8 is preferably not higher than 0.8. When the ratio exceeds 0.8, the gradient structure for physical bond between WC and DLC in mixed layer 8b becomes discontinuous and hence adhesiveness of hard film 8 may become poor.

By forming hard film 8 to have the three-layered structure of underlying layer 8a, mixed layer 8b, and surface layer 8c composed as above in rolling bearing 1 according to the present embodiment, excellent resistance against flaking can be achieved.

<Function and Effect of Rolling Bearing>

Rolling bearing 1 according to the present embodiment includes inner ring 2, outer ring 3, a plurality of rolling elements 4, and hard film 8. Inner ring 2 includes inner-ring raceway surface 2a around an outer circumference. Outer ring 3 includes outer-ring raceway surface 3a around an inner circumference. The plurality of rolling elements 4 roll between inner-ring raceway surface 2a and outer-ring raceway surface 3a. Hard film 8 is formed on a surface of at least one selected from the group consisting of inner ring 2, outer ring 3 and rolling elements 4. Inner ring 2, outer ring 3, and the plurality of rolling elements 4 are composed of an iron-based material.

Hard film 8 includes underlying layer 8a, mixed layer 8b, and surface layer 8c. Underlying layer 8a is directly formed on the surface and mainly composed of chromium (Cr). Mixed layer 8b is formed on underlying layer 8a and mainly composed of tungsten carbide (WC) and diamond like carbon (DLC). Surface layer 8c is formed on mixed layer 8b and mainly composed of diamond like carbon (DLC). Mixed layer 8b is such a layer that a content of tungsten carbide (WC) therein decreases and a content of diamond like carbon (DLC) therein increases continuously or stepwise from a side of underlying layer 8a toward surface layer 8c.

In rolling bearing 1, underlying layer 8a directly formed on the surface and mainly composed of Cr is well compatible with the iron-based material and higher in adhesiveness to the iron-based material than a layer mainly composed of W or Si. Since WC employed for mixed layer 8b has a hardness or an elastic modulus intermediate between Cr and DLC, concentration of residual stress in mixed layer 8b after formation of hard film 8 can be suppressed. Mixed layer 8b mainly composed of WC and DLC has the gradient composition as above so that mixed layer 8b has such a structure that WC and DLC are physically bonded to each other.

According to the structure, hard film 8 is excellent in resistance against flaking when it is formed on a surface of any of inner ring 2, outer ring 3, and rolling element 4. Therefore, hard film 8 formed on any of inner-ring raceway surface 2a, outer-ring raceway surface 3a, and the rolling surface of rolling element 4 can exhibit characteristics inherent to DLC without flaking off. Consequently, rolling bearing 1 is excellent in resistance against seizure, wear resistance, and corrosion resistance and less in damage to the raceway surface even in a severe lubrication state, and has a long lifetime.

From a different point of view, hard film 8 with the structure and physical properties as above is formed in rolling bearing 1 according to the present embodiment, so that wear or flaking of hard film 8 can be suppressed even though a load such as rolling contact is applied to hard film 8 during use of the bearing. Therefore, rolling bearing 1 less in damage to the raceway surface and having a long lifetime even in a severe lubrication state is obtained. When a nascent surface of a metal is exposed due to damage to a rolling bearing ring such as inner ring 2 and outer ring 3 in rolling bearing 1 in which grease 7 is sealed, deterioration of grease is accelerated by catalysis. In rolling bearing 1 according to the present embodiment, however, hard film 8 is formed and hence damage to inner-ring raceway surface 2a, outer-ring raceway surface 3a, and the rolling surface of rolling element 4 due to contact with the metal can be suppressed and deterioration of grease can also be suppressed.

<Method of Manufacturing Rolling Bearing>

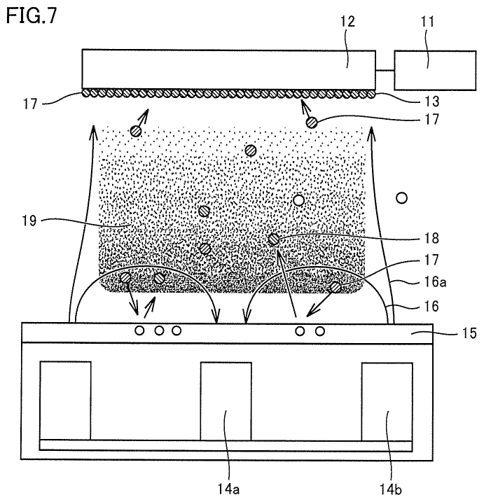

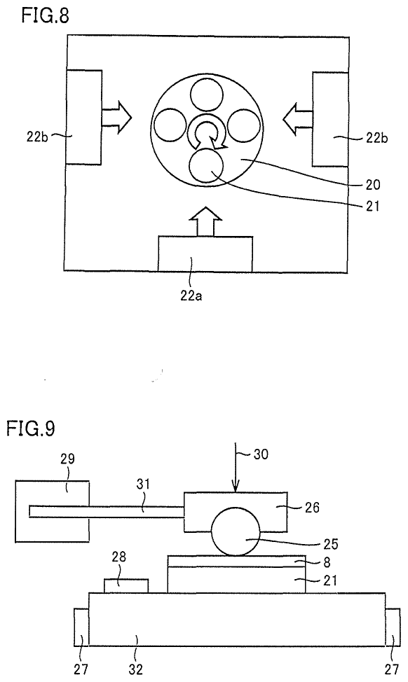

FIG. 6 is a flowchart for illustrating a method of manufacturing the rolling bearing shown in FIGS. 1 to 5. FIG. 7 is a schematic diagram for illustrating principles in film formation by an UBMS method. FIG. 8 is a schematic diagram showing a construction of an exemplary UBMS apparatus.

As shown in FIG. 6, in the method of manufacturing a rolling bearing, initially, a preparation step (S10) is performed. In this step (S10), a component to be a bearing member which forms rolling bearing 1 is prepared. Examples of the component include inner ring 2, outer ring 3, rolling element 4, and sealing member 6.

Then, a film formation step (S20) is performed. In this step (S20), a hard film is formed on a surface of the component prepared in the step (S10). Details of the film formation step (S20) will be described later. Thereafter, an postprocess step (S30) in which finishing or assembly of components having the hard film formed is performed. Rolling bearing 1 shown in FIGS. 1 to 3 can thus be obtained.

A method of forming a hard film in the step (S20) will be described below. Hard film 8 is obtained by forming underlying layer 8a, mixed layer 8b, and surface layer 8c in this order on a film formation surface of a component to serve as a bearing member.

Underlying layer 8a and mixed layer 8b are formed preferably by using an UBMS apparatus in which Ar gas is employed as sputtering gas. Principles in film formation by the UBMS method with the use of the UBMS apparatus will be described with reference to the schematic diagram shown in FIG. 7. In FIG. 7, inner ring 2, outer ring 3, or rolling element 4 representing a component to serve as the bearing member on which a film is to be formed is defined as a substrate 12, and it is schematically shown in a shape like a flat plate. Substrate 12 is connected to a bias power supply 11. As shown in FIG. 7, a target 15 is arranged as being opposed to substrate 12. Target 15 serving as a source of supply of a film formation source material has, for example, a circular two-dimensional shape. An inner magnet 14a and an outer magnet 14b different in magnetic characteristics between a central portion and a peripheral portion of circular target 15 are arranged under circular target 15. For example, outer magnet 14b forms relatively strong magnetic field whereas inner magnet 14a forms relatively weak magnetic field.

According to the UBMS method, inner magnet 14a and outer magnet 14b form magnetic field such that some 16a of magnetic lines of force 16 generated by inner magnet 14a and outer magnet 14b reach the vicinity of substrate 12 while high-density plasma 19 is formed from Ar gas around target 15. Some of high-density plasma 19 (Ar plasma) generated during sputtering is diffused around substrate 12 along some 16a of magnetic lines of force. According to such an UBMS method, Ar plasma 17 and electrons allow ionized particles 18 derived from target 15 to reach substrate 12 in an amount more than in normal sputtering, along some 16a of magnetic lines of force which reach the vicinity of substrate 12. Such an effect is called an ion assisted effect. According to the UBMS method, a dense film 13 can be formed on the surface of substrate 12 owing to the ion assisted effect.

In forming underlying layer 8a, a Cr target is used as target 15. In forming mixed layer 8b, a WC target and a graphite target are used together as target 15. Mixed layer 8b is formed while electric power applied to the graphite target serving as a carbon supply source is increased and electric power applied to the WC target is decreased continuously or stepwise. Thus, a portion of such a gradient composition layer that a content of WC continuously or stepwise decreases and a content of DLC continuously or stepwise increases from the side of underlying layer 8a toward surface layer 8c can be formed in mixed layer 8b.

Surface layer 8c may also be formed by using the UBMS apparatus in which Ar gas is employed as sputtering gas. More specifically, a condition as below can be employed as a condition for forming surface layer 8c. Specifically, the UBMS apparatus is employed, and a graphite target and hydrocarbon-based gas are used together as a carbon supply source. A ratio of an amount of introduction of hydrocarbon-based gas to an amount of introduction defined as 100 of Ar gas into the UBMS apparatus is not lower than 1 and not higher than 10. A degree of vacuum in the UBMS apparatus is not lower than 0.2 Pa and not higher than 0.8 Pa. Under such conditions, particulate carbon produced by sputtering from the carbon supply source is preferably deposited on mixed layer 8b to form surface layer 8c as the DLC film. The conditions above will be described below.

By using the graphite target and hydrocarbon-based gas together as the carbon supply source, a hardness and an elastic modulus of the DLC film can be adjusted. Gas such as methane, acetylene, and benzene can be employed as hydrocarbon-based gas. Though hydrocarbon-based gas is not particularly limited, methane gas is preferably employed from a point of view of cost and handleability.

By setting a ratio of an amount of introduction of hydrocarbon-based gas to 1 to 10 (parts by volume) with respect to an amount of introduction defined as 100 (parts by volume) of Ar gas into the UBMS apparatus (specifically, a film formation chamber of the UBMS apparatus), adhesiveness to mixed layer 8b can be improved without deteriorating wear resistance of surface layer 8c.

A degree of vacuum in the film formation chamber is preferably not lower than 0.2 Pa and not higher than 0.8 Pa as described above. More preferably, the degree of vacuum is not lower than 0.25 Pa and not higher than 0.8 Pa. When the degree of vacuum is lower than 0.2 Pa, an amount of Ar gas in the film formation chamber is small and hence no Ar plasma is generated and surface layer 8c may not be formed. When the degree of vacuum in the film formation chamber is higher than 0.8 Pa, a reverse sputtering gas phenomenon tends to occur and wear resistance of surface layer 8c may become poor.

<Function and Effect of Method of Manufacturing Rolling Bearing>

As shown in FIG. 6, the method of manufacturing rolling bearing 1 includes steps of preparing an inner ring, an outer ring, and a rolling element (S10) and forming a hard film (the film formation step (S20)). In the step of forming a hard film (S20), hard film 8 is formed on a surface of at least one selected from the group consisting of inner ring 2, outer ring 3, and rolling element 4. In the step of forming a hard film (S20), an unbalanced magnetron sputtering (UBMS) apparatus in which argon gas is employed as sputtering gas is used. In the step of forming a hard film (S20), a graphite target and hydrocarbon-based gas are used together as a carbon supply source, and a ratio of an amount of introduction of hydrocarbon-based gas to an amount of introduction defined as 100 of argon gas into the apparatus is not lower than 1 and not higher than 10. In the step of forming a hard film (S20), surface layer 8c is formed by deposition of carbon atoms originating from the carbon supply source on mixed layer 8b. By doing so, rolling bearing 1 excellent in durability according to the present embodiment can be obtained.

In the method of manufacturing a rolling bearing, surface layer 8c formed in the step (S20) may include on a side adjacent to mixed layer 8b, gradient layer portion 8d having a hardness increasing continuously or stepwise from a side of mixed layer 8b. In this case, in the step of forming a hard film (S20), gradient layer portion 8d is formed while a bias voltage to be applied to at least one selected from the group consisting of inner ring 2, outer ring 3, and rolling element 4 including a surface is increased continuously or stepwise. By doing so, gradient layer portion 8d can readily be formed.

In the method of manufacturing a rolling bearing, in the step of forming a hard film (S20), underlying layer 8a and mixed layer 8b may be formed by using the UBMS apparatus in which argon gas is employed as sputtering gas as described above. In the step of forming a hard film (S20), mixed layer 8b may be formed while sputtering power to be applied to the graphite target serving as the carbon supply source is increased continuously or stepwise and electric power to be applied to the tungsten carbide target is lowered continuously or stepwise. By doing so, a composition of WC and DLC in mixed layer 8b can be changed in the direction of thickness.

The method of manufacturing a rolling bearing may include a step of forming a nitride layer by performing nitriding treatment on a surface where hard film 8 is to be formed, before the step of forming a hard film (S20). Plasma nitriding treatment may be performed as nitriding treatment.

In the method of manufacturing a rolling bearing, in the step of forming a hard film (S20), a surface where hard film 8 is to be formed may have surface roughness Ra not greater than 0.05 μm. In this case, hard film 8 with suppressed variation in thickness can be formed.

The method of manufacturing a rolling bearing may further include a step of sealing grease around rolling element 4. In this case, rolling bearing 1 in which grease 7 is sealed can be obtained.

### EXAMPLE

In order to confirm an effect of the hard film formed in the rolling bearing according to the present embodiment, a hard film was formed on a prescribed substrate and physical properties of the hard film were evaluated. Resistance against flaking was evaluated in a friction and wear test by using a reciprocating-motion sliding test apparatus. Specific description will be given below.

<Sample>

Specimens of seven types of samples Nos. 1 to 7 were prepared. A material property of the specimens used for evaluation of the hard film and conditions for forming the hard film are as below.

(1) Material property of substrate: SUJ2 defined under JIS standard, a quenched and tempered product having a surface hardness of 780 Hv

(2) Substrate: a mirror-polished flat plate with the material property of the substrate above (having surface roughness of 0.02 μm Ra), Shape of substrate: a circular two-dimensional shape, a diameter of 33 mm×a thickness of 6 mm

(3) UBMS apparatus: UBMS 202 manufactured by Kobe Steel, Ltd.

FIG. 8 is a schematic diagram of an UBMS apparatus. The UBMS apparatus shown in FIG. 8 was provided with an arc ion plating (which is denoted as AIP below) function. As shown in FIG. 8, the UBMS apparatus had an AIP function to instantaneously vaporize and ionize an AIP evaporation source material 22a onto a substrate 21 arranged on a disc 20 by using vacuum arc discharge to thereby deposit the material on substrate 21 and form a coating. The UBMS apparatus had an UBMS function to control characteristics of a coating to be deposited on the substrate by forming magnetic field in a non-equilibrium state between a target 22b serving as a sputtering evaporation source material and substrate 21 and increasing a plasma density in the vicinity of substrate 21 by the magnetic field to enhance the ion assisted effect (see FIG. 7). With this apparatus, a composite coating resulting from arbitrary combination of an AIP coating and a plurality of UBMS coatings (including a composition gradient portion) could be formed on substrate 21. In samples Nos. 1 to 7, an underlying layer, a mixed layer, and a surface layer were formed as the UBMS coating on a surface of a flat plate serving as the substrate.

(4) Sputtering gas: Ar gas

(5) Condition for forming underlying layer and mixed layer:

Underlying layer: A vacuum was produced in a film formation chamber to approximately 5×10⁻³ Pa, and a specimen was baked by a heater to etch its surface by Ar plasma. Thereafter, by the UBMS method, sputtering power to be applied to a Cr target and a WC target was adjusted to set a gradient of a composition ratio between Cr and WC, so that a Cr/WC gradient layer in which Cr was dominant on a side of the substrate and WC was dominant on a side of the surface was formed.

Mixed layer: By the UBMS method, sputtering power to be applied to a WC target and a graphite target was adjusted to set a gradient of a composition ratio between WC and DLC, so that a WC/DLC gradient layer in which WC was dominant on a side of the underlying layer and DLC was dominant on the side of the surface was formed. A condition for forming the mixed layer was basically similar to the condition for forming the underlying layer, other than sputtering power described above. The underlying layer and the mixed layer described above were formed under the same conditions for samples Nos. 1 to 7.

(6) Condition for forming surface layer:

A surface layer was formed under conditions shown in Table 1 for each of samples Nos. 1 to 7.

(7) Method of manufacturing each sample:

A substrate shown in Table 1 which will be described later was subjected to ultrasonic cleaning with the use of acetone and thereafter dried. After drying, the substrate was attached to the UBMS apparatus and the underlying layer and the mixed layer were formed under the film formation conditions described above. On those layers, a DLC film serving as the surface layer was formed under the film formation conditions shown in Table 1 to obtain a specimen with a hard film. A “degree of vacuum” in the table represents a degree of vacuum in the film formation chamber in the apparatus.

<Test Method>

Reciprocating-Motion Sliding Test:

A test of resistance against flaking by sliding was conducted for obtained samples Nos. 1 to 7 by using a reciprocating-motion sliding test apparatus shown in FIG. 9. The reciprocating-motion sliding test apparatus shown in FIG. 9 included a base 32 on which a sample having substrate 21 and hard film 8 formed was held, a load cell 27 and an acceleration sensor 28 set on base 32, a silicon nitride ball 25 as a ball with which hard film 8 of the sample was brought in contact, a holder 26 which held silicon nitride ball 25, an arm 31 connected to holder 26, and a shaker 29 which laterally vibrated arm 31. Holder 26 was able to apply a load in a direction shown with an arrow 30.

The test was conducted without lubrication. In the test, a load was increased and a load at the time when a friction coefficient was increased by flaking of hard film 8 was defined as a limit load. Specific test conditions are shown below.

(Test Condition)

Lubrication: none

Ball: ⅜-inch silicon nitride ball

Load: 30 to 80 N

Rate of increase in load: 10 N/min.

Vibration frequency: 60 Hz

Amplitude: 2 mm

Measurement of Indentation Hardness:

An indentation hardness of hard film 8 of each sample was measured by using a nanoindenter (G200) manufactured by Agilent Technologies. An average value at a depth not affected by surface roughness (a portion where a hardness was stable) was adopted as a measurement value and measurement was conducted at ten locations for each sample.

<Result>

Table 1 shows conditions for the samples and results of the test.

TABLE 1

| | 1 | 2 | 3 | 4 | 5 | 6 | 7 |
|---|---|---|---|---|---|---|---|
| Material Property of | SUJ2 | SUJ2 | SUJ2 | SUJ2 | SUJ2 | SUJ2 | SUJ2 |
| Substrate | | | | | | | |
| Substrate Hardness, Hv | 780 | 780 | 780 | 780 | 780 | 780 | 780 |
| Substrate Surface | 0.005 | 0.005 | 0.005 | 0.005 | 0.005 | 0.005 | 0.005 |
| Roughness, μm Ra | | | | | | | |
| Material Property of | Cr/WC | Cr/WC | Cr/WC | Cr/WC | Cr/WC | Cr/WC | Cr/WC |
| Underlying Layer | | | | | | | |
| Material Property of | WC/DLC | WC/DLC | WC/DLC | WC/DLC | WC/DLC | WC/DLC | WC/DLC |
| Mixed Layer | | | | | | | |
| Condition for Formation | | | | | | | |
| of Outermost Layer | | | | | | | |
| Ratio of Introduction | 3.0 | 3.0 | 10.0 | 12.0 | 12.0 | 6.0 | 3.0 |
| of Methane Gas | | | | | | | |
| Degree of Vacuum, Pa | 0.85 | 0.85 | 0.25 | 0.8 | 0.4 | 0.8 | 0.25 |
| Bias Voltage (negative), V | 50 | 75 | 100 | 100 | 100 | 100 | 100 |
| Indentation Hardness | 12.6 | 14.3 | 20.1 | 10.3 | 13.0 | 13.2 | 24.5 |
| Average Value, GPa | | | | | | | |
| Vickers Hardness Obtained | 1190 | 1348 | 1899 | 980 | 1230 | 1250 | 2315 |
| by Conversion | | | | | | | |
| Thickness, μm | 2.1 | 2.0 | 1.9 | 2.0 | 1.9 | 2.0 | 1.9 |
| Reciprocating-Motion | | | | | | | |
| Sliding Test Limit Load in | | | | | | | |
| Reciprocating Sliding, N | | | | | | | |
| Test 1 | 80 or | 51.4 | 73.4 | 120 or | 100 or | 77.9 | 30.5 |
| | higher | | | higher | higher | | |
| Test 2 | 80 or | 54.6 | 80 | 120 or | 100 or | 83.4 | 46.9 |
| | higher | | | higher | higher | | |
| Average Value | 80 or | 53.1 | 76.7 | 120 or | 100 or | 80.7 | 38.7 |
| | higher | | | higher | higher | | |

The underlying layer and the mixed layer in Table 1 are expressed as “first component/second component” because they were composed by mixing two components. A ratio of introduction of methane gas represents a ratio of an amount of introduction of methane gas to an amount of introduction defined as 100 of argon gas.

As is understood from Table 1, with an indentation hardness of the surface layer of hard film 8 being varied, in a region where the indentation hardness was not higher than 15 GPa, a limit load in the reciprocating-motion sliding test tended to be high when the hardness was low.

Though an embodiment of the present invention has been described as above, the embodiment described above can also variously be modified. The scope of the present invention is not limited to the embodiment and Example described above. The scope of the present invention is defined by the terms of the claims and is intended to include any modifications within the scope and meaning equivalent to the terms of the claims.

### INDUSTRIAL APPLICABILITY

A sliding surface and a rolling surface to which application of DLC is considered is often in a severe lubrication state such as insufficient lubrication or a high sliding speed. Since the rolling bearing according to the present embodiment has DLC formed, for example, on an inner-ring or outer-ring raceway surface or a rolling surface of a rolling element, the rolling bearing is excellent in resistance against flaking and characteristics of DLC itself can be exhibited even though the rolling bearing is operated in a severe lubrication state. Therefore, the rolling bearing is excellent in resistance against seizure, wear resistance, and corrosion resistance. Therefore, the rolling bearing can be applied to various applications including an application in a severe lubrication state.

### REFERENCE SIGNS LIST

1 rolling bearing; 2 inner ring; 2a inner-ring raceway surface; 3 outer ring; 3a outer-ring raceway surface; 4 rolling element; 5 cage; 6 sealing member; 7 grease; 8 hard film; 8a underlying layer; 8b mixed layer; 8c surface layer; 8d gradient layer portion; 11 bias power supply; 12, 21 substrate; 13 film; 14a inner magnet; 14b outer magnet; 15, 22b target; 16 magnetic line of force; 16a some; 17 Ar plasma; 18 particle; 19 high-density plasma; 20 disc; 22a evaporation source material; 25 silicon nitride ball; 26 holder; 27 load cell; 28 acceleration sensor; 29 shaker; 30 arrow; 31 arm; 32 base

1. A rolling bearing comprising:
an inner ring including an inner-ring raceway surface around an outer circumference;
an outer ring including an outer-ring raceway surface around an inner circumference;
a plurality of rolling elements which roll between the inner-ring raceway surface and the outer-ring raceway surface; and
a hard film formed on a surface of at least one selected from the group consisting of the inner ring, the outer ring, and the rolling elements,
the inner ring, the outer ring, and the plurality of rolling elements being composed of an iron-based material,
the hard film including
an underlying layer directly formed on the surface and mainly composed of chromium,
a mixed layer formed on the underlying layer and mainly composed of tungsten carbide and diamond like carbon, and
a surface layer formed on the mixed layer and mainly composed of diamond like carbon,
the mixed layer being such a layer that a content of the tungsten carbide in the mixed layer decreases and a content of the diamond like carbon in the mixed layer increases continuously or stepwise from a side of the underlying layer toward the surface layer.

2. The rolling bearing according to claim 1, wherein the surface layer has an indentation hardness not lower than 10 GPa and not higher than 20 GPa.

3. The rolling bearing according to claim 1, wherein
the surface layer includes on a side adjacent to the mixed layer, a gradient layer portion having a hardness increasing continuously or stepwise from a side of the mixed layer.

4. The rolling bearing according to claim 1, wherein
the iron-based material is one selected from the group consisting of high-carbon chromium bearing steel, carbon steel, tool steel, and martensitic stainless steel.

5. A method of manufacturing the rolling bearing according to claim 1 comprising:
preparing the inner ring, the outer ring, and the rolling elements; and
forming the hard film on the surface of at least one selected from the group consisting of the inner ring, the outer ring, and the rolling elements,
in the forming the hard film, an unbalanced magnetron sputtering apparatus in which argon gas is employed as sputtering gas being used, a graphite target and hydrocarbon-based gas being used together as a carbon supply source, a ratio of an amount of introduction of the hydrocarbon-based gas to an amount of introduction defined as 100 of the argon gas into the apparatus being not lower than 1 and not higher than 10, and the surface layer being formed by deposition of carbon atoms originating from the carbon supply source on the mixed layer.

6. The method of manufacturing the rolling bearing according to claim 5, wherein
methane gas is employed as the hydrocarbon-based gas.

7. The method of manufacturing the rolling bearing according to claim 5, wherein
the surface layer includes on a side adjacent to the mixed layer, a gradient layer portion having a hardness increasing continuously or stepwise from a side of the mixed layer, and
in the forming the hard film, the gradient layer portion is formed while a bias voltage to be applied to at least one selected from the group consisting of the inner ring, the outer ring, and the rolling elements which include the surface is increased continuously or stepwise.

8. The method of manufacturing the rolling bearing according to 5, wherein
in the forming the hard film, the underlying layer and the mixed layer are formed by using the unbalanced magnetron sputtering apparatus in which argon gas is employed as sputtering gas, and
in the forming the hard film, the mixed layer is formed while sputtering power to be applied to the graphite target serving as the carbon supply source is increased continuously or stepwise and electric power to be applied to a tungsten carbide target is lowered continuously or stepwise.
